(19) United States
(12) Patent Application Publication
(10) Pub. No.: US 2011/0122142 A1
(43) Pub. Date: May 26, 2011

(54) CONTENT PRESENTATION PROTECTION SYSTEMS AND METHODS

(75) Inventors: David Wyatt, San Jose, CA (US); Philip Brown, Santa Cruz, CA (US); David Stears, San Jose, CA (US); Devang Sachdev, Campbell, CA (US)

(73) Assignee: NVIDIA CORPORATION, Santa Clara, CA (US)

(21) Appl. No.: 12/625,420

(22) Filed: Nov. 24, 2009

(51) Int. Cl. G09G 5/00

(52) U.S. Cl. 345/581

(57) ABSTRACT

Systems and methods for protecting display presentation information are presented. In one embodiment, graphics processing method includes receiving presentation information; performing an unauthorized display protection process; and forwarding result of the alteration in the presentation information. In one exemplary implementation the unauthorized display protection process introduces a characteristic in the graphics data signal that is compatible with an authorized display (e.g., trusted display, internal display, etc.) while distorting the graphics data signal in a manner that is not compatible with accurate presentation by an unauthorized display (e.g., untrusted display, external display, etc.). It is appreciated that a variety of characteristics that can be introduced or altered in the presentation information signal. In one embodiment, alterations are made to standard control signals (e.g., stuffing begin/end indications, blank start/end indications, reset indicators, etc.) and the alterations can create new or non-standard indications (e.g., value, character, pattern, etc.).

### FIELD OF THE INVENTION

The present invention relates to the field of displaying presentations associated with graphics processing units.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems facilitate increased productivity and cost reduction in analyzing and communicating data, ideas and trends in most areas of business, science, education and entertainment. Frequently, these activities often involve the dissemination of information through the presentation of various information on a display.

While there are a variety of different types of information that can be disseminated there is typically a desire to control and often restrict the dissemination of the information. For example, various video, graphics, etc. information often includes proprietary content that are subject to limited licenses. However there are a variety of areas in the generation, processing and presentation of information that are susceptible to unauthorized use of the content. For example, the communications between processors and a final display presentation are often susceptible to unauthorized snooping. There are a variety of conventional mechanisms that attempt to provide a degree of protection and control in the dissemination of the information, but these conventional approaches typically involve a tradeoff in protection versus complexity that are relatively resource intensive. Generally, the greater the protection measures the greater the expenditure of resources that are required to provide the protection. For example, external display configurations often utilize High-bandwidth Digital Content Protection (HDCP). However, approaches such as HDCP typically create added complexity and challenges that are very difficult and undesirable for a variety of systems that internal displays (e.g., a notebook LCD Panel, etc.) and limited resources available for complex encryption (e.g., notebook, laptop, resource limited systems, etc.).

### SUMMARY

Systems and methods for protecting display presentation information are presented. In one embodiment, a graphics processing method includes receiving presentation information; performing an unauthorized display protection process; and forwarding results of the alteration in the presentation information. In one exemplary implementation, the unauthorized display protection process introduces a characteristic in the graphics data signal that is compatible with an authorized display (e.g., trusted display, internal display, etc.) while distorting the graphics data signal in a manner that is not compatible or decipherable for accurate presentation by an unauthorized display (e.g., untrusted display, external display, etc.). It is appreciated that a variety of characteristics that can be introduced or altered in the presentation information signal. In one embodiment, alterations are made to standard control signals (e.g., stuffing begin/end indications, blank start/end indications, reset indicators, etc.) and the alterations can create new or non-standard indications (e.g., value, character, pattern, etc.).

### DESCRIPTION OF THE DRAWINGS

The accompanying drawings, which are incorporated in and form a part of this specification, are included for exemplary illustration of the principles of the present invention and not intended to limit the present invention to the particular implementations illustrated therein. The drawings are not to scale unless otherwise specifically indicated.

FIG. 1 is a block diagram of an exemplary graphics processing device in accordance with one embodiment of the present invention.

FIG. 2A is a block diagram of an exemplary presentation information signal in accordance with one embodiment of the present invention.

FIG. 2B is a block diagram of an exemplary presentation information signal in which standard values are reversed in order or sequence in accordance with one embodiment of the present invention.

FIG. 3A is a block diagram of an exemplary presentation system in accordance with one embodiment of the present invention.

FIG. 3B is a block diagram of an exemplary display port encoder in accordance with one embodiment of the present invention.

FIG. 4A is a flow chart of an exemplary graphics processing method in accordance with one embodiment of the present invention.

FIG. 4B is a block diagram of an exemplary unauthorized display protection process or method in accordance with one embodiment of the present invention.

FIG. 5 is a block diagram of an exemplary computer system, one embodiment of a computer system upon which embodiments of the present invention can be implemented.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

Portions of the detailed description that follows are presented and discussed in terms of a method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “processing”, “computing”, “calculating”, “determining”, “displaying”, “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in modulated data signals such as carrier waves or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc, that perform particular tasks or implement particular abstract data types. Typically the functionality of the program modules may be combined or distributed as desired in various embodiments.

Furthermore, while embodiments described herein may make reference to a GPU, it is to be understood that the circuits and/or functionality described herein could also be implemented in other types of processors, such as general-purpose or other special-purpose coprocessors, or within a CPU. Although embodiments described herein may make reference to a CPU and a GPU as discrete components of a computer system, those skilled in the art will recognize that a CPU and a GPU can be integrated into a single device, and a CPU and GPU may share various resources such as instruction logic, buffers, functional units and so on; or separate resources may be provided for graphics and general-purpose operations. Accordingly, any or all of the circuits and/or functionality described herein as being associated with GPU could also be implemented in and performed by a suitably configured CPU.

The present invention facilitates efficient and effective protection of information in a variety of system configurations. In one embodiment, a graphics processing system includes a graphics processing unit for processing graphics information and an internal display. In one exemplary implementation, a non-standard value or alteration is introduced to a presentation information signal. The non-standard value or alteration is compatible with the internal display but not an external display. For example, the internal display can resolve (e.g., accurately interpret, decode, etc.) the non-standard value or alteration to provide an accurate or intelligible presentation while the non-standard value or alteration causes an incompatibility or mis-synchronization with the external display resulting in a distorted or incomprehensible presentation.

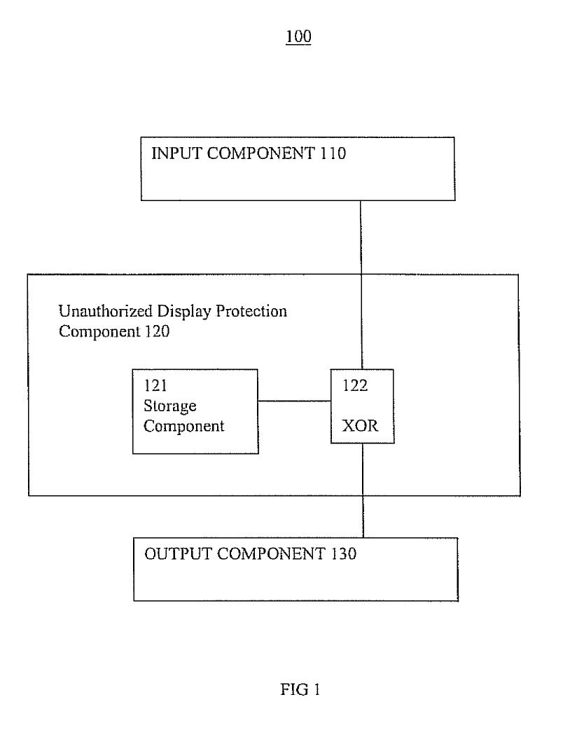

FIG. 1A is a block diagram of exemplary graphics processing device 100 in accordance with one embodiment of the present invention. Graphics processing device 100 includes an input component 110, an unauthorized display protection component 120 and an output component 130. Input component 110 is communicatively coupled to unauthorized display protection component 120 which is communicatively coupled to output component 130. In one embodiment, output component 130 is communicatively coupled to a display 140.

The components of graphics processing device 100 cooperatively operate to protect presentation information. Input component 110 receives graphics data. Unauthorized display protection component 120 introduces a non-standard alteration or value to a presentation information signal associated with the presentation data. In one embodiment, unauthorized display protection component 120 introduces a non-standard alteration or value to a presentation information signal if the presentation signal is authorized to be forwarded to a trusted device (e.g., an internal display) and not authorized to be forwarded to an untrusted device (e.g., an external display). Output component 130 outputs or forwards results from the unauthorized display protection component 120.

It is appreciated there are a variety of alterations to different characteristics of the presentation information signal that unauthorized display protection component 120 can introduce. In one embodiment, alterations are made to standard control signals (e.g., stuffing begin/end indications, blank start/end indications, etc.). The alterations can create new or non-standard indications (e.g., value, character, pattern, etc.). In one embodiment, the alterations or changes in the presentation information signal are coordinated with the system resources to minimize impacts to design. In one exemplary implementation, a single bit in a presentation information signal value (e.g., single bit in a reset value, control value, fill start/end indicator, etc.) is altered from a standard value. Altering a single bit permits the value to remain compatible with protocols and minimize design impacts (e.g., remain compatible with TCON, less gate design changes to display components, etc.).

In one embodiment, alterations are made to stuffing begin/end indications or signals used to indicate beginnings and ends of inactive transmission intervals. In one embodiment, a display port forwards information on a link with a fixed link speed but the pixel speed depends upon the resolution. The link can have bursts of pixel data with gaps in between in which fill information is forwarded. The synchronization of the information is encoded with a fill start and end indicator. In one exemplary implementation, the fill start and end indicators can be 10 bit symbols or values designated by an 8 bit to 10 bit (8B/10B) encoding scheme. In one embodiment, the fill start and end indicators are not scrambled and can be readily detected.

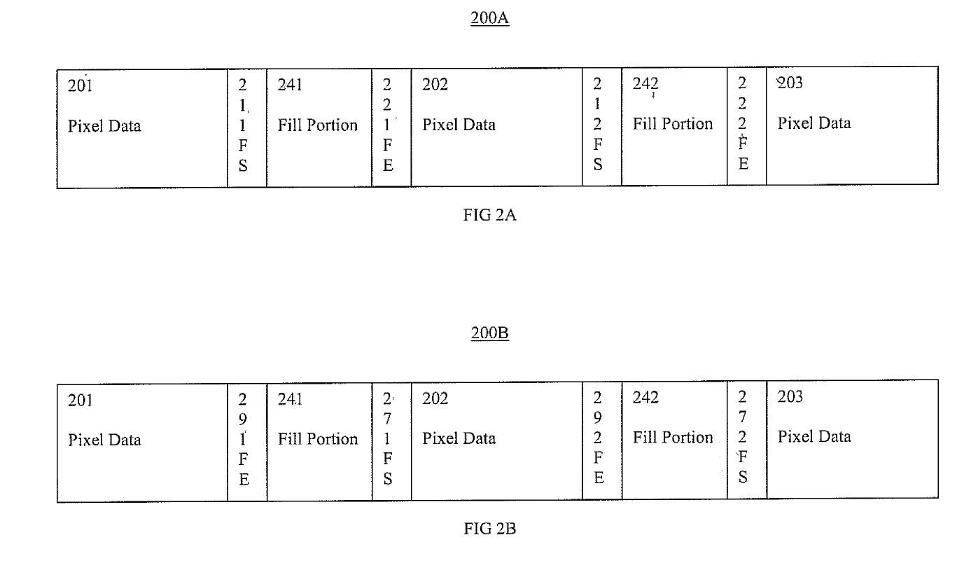

FIG. 2A is a block diagram of exemplary presentation information signal 200A in accordance with one embodiment of the present invention. Presentation information signal 200A includes: pixels data portions 201, 202 and 203; fill start indications 211 and 212; fill end indications 221 and 222; and fill portions 241 and 242. Pixel data portions 201, 202 and 203 include pixel data information. Fill start indications 211 and 212 indicate the beginning of a fill portion. Fill end indications 221 and 222 indicate the end of a fill portion. Fill portions 241 and 242 include fill information. The fill information or value can be arbitrary or pre-determined. Utilizing non-standard stuffing begin/end indications causes issues on untrusted devices (e.g. convention external panels) which only understand the conventional indications or patterns (e.g., a pattern used in the conventional Display Port standard). The alteration causes a loss of synchronization of stuffing fill begin and ends resulting in a distorted or unintelligible display in unauthorized or untrusted displays that are not compatible with the alteration or non-standard. For example, the unauthorized or external display can not determine whether information is pixel information of fill information since the unauthorized display can not properly recognize the fill start and end indications, resulting in the fill information “polluting” the pixel image.

In one embodiment, the alteration includes reversing the order of values or indications in control signals (e.g., blank start after blank end or fill start after fill end). It is appreciated the values of the control indicators can be standard values presented in reversed order or sequence. In one exemplary implementation fill start and fill end indicator order is reversed so that the fill end indicator is utilized to indicate a fill start and a fill start indicator is utilized to indicate a fill end. FIG. 2B is a block diagram of exemplary presentation information signal 200B in which standard values (e.g., fill start indicators and fill end indicators) are reversed in order or sequence in accordance with one embodiment of the present invention. For example, standard fill end indications 291 and 292 indicate the start of a fill portion (e.g., fill portion 241 and 242 respectively) and fill start indications 271 and 272 indicate the end of a fill portion (e.g., fill portion 241 and 242 respectively). Reversing the order or sequence of the fill start and fill end indicators again creates non-standard or non-compliant states that confuse the unauthorized or untrusted devices (e.g., external displays) rendering them unable to distinguish between intervals of active pixels and other components of the signal (e.g., vertical/horizontal blanking, stuffing patterns, etc.) resulting in a loss of synchronization and unintelligible display in unauthorized or untrusted displays that are not compatible with the alteration or non-standard.

In one embodiment, on reset, a pre-determined or non-standard value is introduced in a scrambler or parallel pixel data to serial conversion unit in a graphics controller. A reset can occur at various points in the processing or forwarding of presentation information and can occur at regular time intervals. The pre-determined or non-standard value can be one that is unkown by an unauthorized or untrusted communication path or device. In one exemplary implementation, a standard external display on the receiving side using the reset pattern defined in a standard specification will be out of sync with the transmitting component resulting in unintelligible or distorted presentation on the unauthorized or untrusted display. In one exemplary implementation the pre-determined or non-standard value is loaded into a Linear Feedback Register (LFSR) in a graphics controller. It is appreciate that there can be multiple Linear Feedback Registers (LFSRs) and the pre-determined or non-standard value can be loaded in a LFSR associated with a scrambler or encoder for an internal display and not loaded in a LFSR associated with a scrambler encoder for an external display, HDCP operations, etc.

It is appreciated that a variety or alterations or approaches can be combined. For example, a reset value can be altered and the order of fill start and end indications can be reversed. Both the fill start and end indication values and blank begin and end values can be altered to non-standard values. The combination can include a change to the reset value and blank begin and end values. The combination can also include a change to the reset value, fill start and end values, and blank begin and end values.

With reference again to FIG. 1, in one embodiment, unauthorized display protection component 120 includes a storage component 121 communicatively coupled to a combination component 122. Storage component 121 stores a scrambling value. In one embodiment, the storage component 121 is a left feed shift register LFSR. In one exemplary implementation, the scrambling value in storage component is set or reset to cause an incompatibility with an unauthorized or unintended display. For example, a standard value for a reset may be storing all logical 1 indications in the scrambler reset LFSR which can be altered to a present non-standard value with one or more logical 0 indications included in the value. Combination component 122 combines the graphics data with the scrambling value. In one exemplary implementation the combination component is an exclusive OR component.

It is appreciated that systems and methods in accordance with the present invention can be readily implemented to be compatible with a variety of scrambling values. In one embodiment, the scrambling value is a reset to a first value if the output results are forwarded to an internal display device and is reset to a second value if the output results are forwarded to an external display device. The scrambling value can be a pseudo random value. The scrambling value can be altered to affect a discontinuity in the ability of an unauthorized or unintended receiver to unscramble the output results.

It is also appreciated that systems and methods in accordance with the present invention can be readily implemented to be utilized within systems that can include both an internal and external display. In one embodiment, a graphics processing system can have multiple display ports which can be assigned internal and/or external displays. In one embodiment, a selection is made between multiple displays and whether the presentation information is to be forwarded to an internal or external display. The selection and feature of the display (e.g., whether secure or unsecure, trusted or untrusted, internal or external, etc.) can be reported to an application. If the information is to be forwarded to an internal display, a non-standard value or alteration that is compatible with the internal display but not an external display is introduced to a presentation information signal. If the information is to be forwarded to an external display, standard values or values compatible with the external display can be utilized. In one exemplary implementation, if the information is to be forwarded to an external device no alterations from standard values are introduced and HDCP is utilized to encode the presentation information for communication to the external display.

It is further appreciated that systems and methods in accordance with the present invention can be implemented to utilize non-standard or non-conventional values or alterations while being otherwise compliant with a variety of standards or conventions. For example, the present systems and methods can be configured to be compatible with the Display Port Specification. In one embodiment, a presentation information signaling protocol introduces a feature (e.g., an altered control indication, reset value, etc.) that is incompatible and incomprehensible by an unauthorized display device while maintaining physical interface characteristics compliant with the Display Port Specification. The Display Port Specification is a display signaling and connector standard that can be used on an internal as well as an external display. The Display Port Specification can be considered an effort to unify diverging internal and external display port standards while attempting to provide support for broader application of technology advances and facilitate cost reductions. Since the connectors used for Internal and External Display Port panels are part of the standard, and the conventional signaling is hypothetically compatible and it is expected that cables which otherwise convert from one to the other will be commercially available (e.g., for testing, manufacturing purposes, etc.). Without relying on complicated and resource intensive approaches (e.g., HDCP, etc.), systems and methods in accordance with one embodiment of the present invention ensure that a display connector utilized with an internal display is not trivially reconnected to an external display in an undesirable or unauthorized manner.

It is appreciated the systems and methods in accordance with the present invention offer a flexible and efficient technique for protecting presentation information from unauthorized display. For example, premium content licenses are adding support for the Display Port Specification. However, conventional premium content licenses are adding support on the condition that conventional HDCP is used to protect the display content regardless of whether the content is displayed on an internal or external device. As indicated previously, it is difficult and complicated for resource limited systems with internal displays (e.g., notebooks, etc.) to implement HDCP. The systems and methods in accordance with the present invention provide an effective resource efficient alternative to system component manufactures and licensed content providers that facilitates controlled authorized display on internal displays while preventing inappropriate display of content on an external display unbeknownst to a licensed content player.

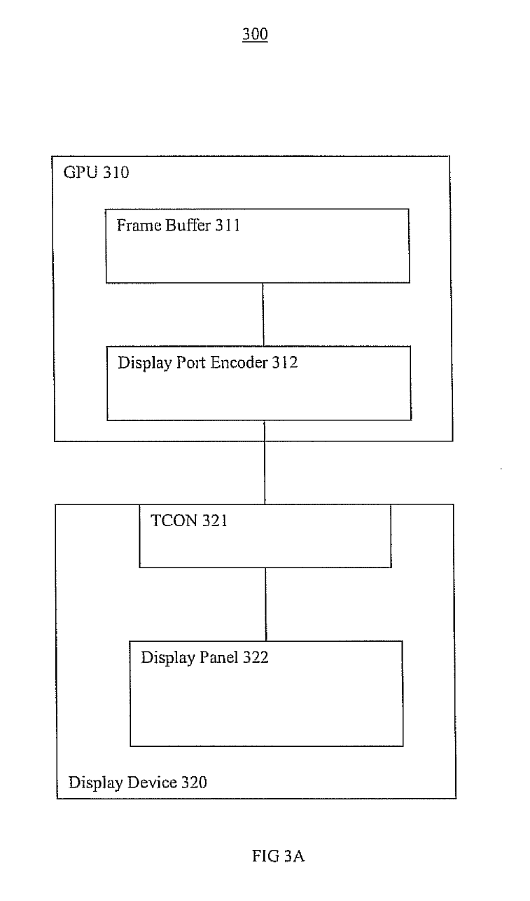

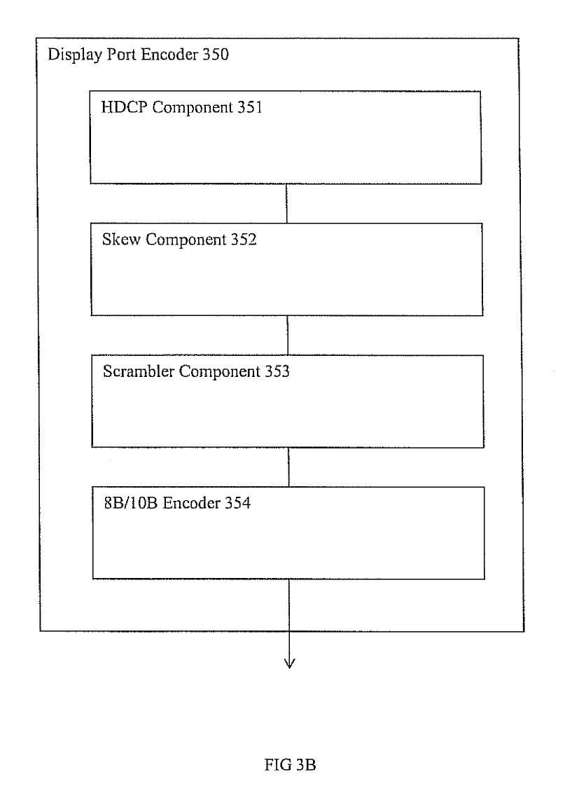

FIG. 3A is a block diagram of an exemplary presentation system 300 in accordance with one embodiment of the present invention. Presentation system 300 includes graphics processing unit (GPU) 310 communicatively coupled to display device 320. Graphics processing unit (GPU) 310 includes frame buffer 311 communicatively coupled to display port encoder 312. Display device 320 which includes TCON component 321 communicatively coupled to display panel 322. Display port encoder 312 is communicatively coupled to TCON component 321. In one embodiment display port encoder 312, TCON component 321, and the communication link between them are compatible with the Display Port Specification. For example, the display port encoder 312 and TCON component 321 are communicatively coupled by 4 lines and a sideband link. In one exemplary implementation the sideband link can be utilized to indicate whether the display device 320 is internal or external and whether display device 320 is compatible with present techniques of non-standard alterations to the presentation information signal. In one embodiment, the display port encoder 312 alters presentation information signals in accordance with one embodiment of the present invention and TCON component 321 interprets the signals to decode and reconstruct the presentation data.

FIG. 3B is a block diagram of exemplary display port encoder 350 in accordance with one embodiment of the present invention. In one embodiment, display port encoder 350 is similar to display port encoder 312. Display port encoder 351 includes High-bandwidth Digital Content Protection (HDCP) component 351, skew component 352, scrambler 353 and 8B/10B component 354. HDCP component 351 is communicatively coupled to skew component 352 which in turn is communicatively coupled to scrambler 353. Scrambler 353 is communicatively coupled to 8B/10B component 354 which in turn is communicatively coupled to a display port output.

The components of exemplary display port encoder 351 cooperatively operate to encode presentation information for communication to a display device. High-bandwidth Digital Content Protection (HDCP) component 351 encrypts or encodes the presentation information in accordance with HDCP license protocols for utilization with external displays. If the information is going to be forwarded to an internal display the HDCP encryption is not performed on the information. Skew component 352 can be utilized to adjust or add a skew to the presentation information signal. Scrambler component 253 scrambles the information signal. In one embodiment, scrambler component 253 includes a storage component communicatively coupled to a combination component and operates similar to storage component 121 and combination component 122 in FIG. 1. In one exemplary implementation, scrambler component 253 does not scramble the information signal (e.g., with a non-standard value, alterations to begin/end indications, etc.) if the presentation information is authorized to be forwarded to an external display. It is appreciated that the scrambler component 253 can scramble the information signal in a manner that reduces frequency spikes (e.g. to reduce electromagnetic interference (EMI), etc.) regardless of whether forwarding to an internal or external display. The 8B/10B component 354 performs 8 bit to 10 bit encoding for communication off of display port.

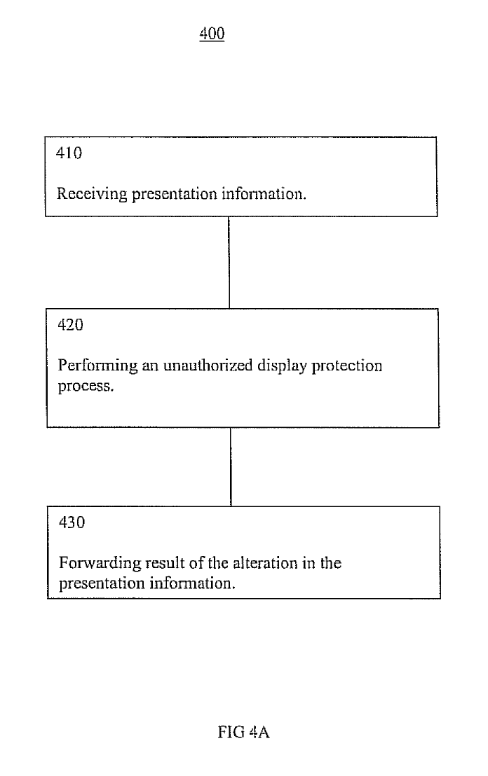

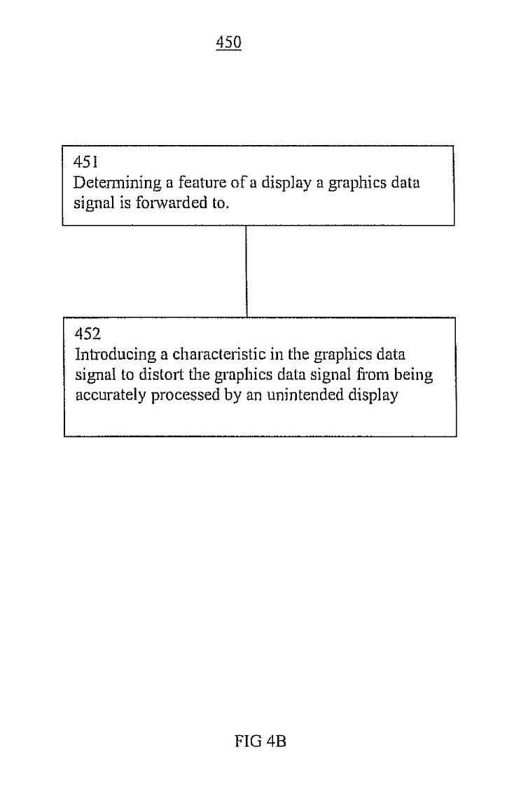

FIG. 4A is a flow chart of exemplary graphics processing method 400 in accordance with one embodiment of the present invention. In one embodiment, graphics processing method 400 facilitates efficient protection of presentation information. In one exemplary implementation, graphics processing method 400 facilitates protection of presentation information intended for an internal display presentation from display on an external display.

In block 410, presentation information is received. It is appreciated a variety of presentation information can be received. For example, the presentation information can be video information, graphics information, etc.

An unauthorized display protection process is performed at block 420. In one embodiment, the unauthorized display protection process introduces an alteration in the presentation information signal that is compatible with an authorized or trusted display device but causes a disrupted presentation in an unauthorized or untrusted device. In one exemplary implementation the unauthorized display protection process introduces a non-standard adjustment to a presentation information signal that is resolvable by an authorized device but not resolvable by an unauthorized device. It is appreciated that a variety of adjustments to the presentation information signal can be utilized. In addition to the examples previously described, further description of exemplary unauthorized display protection process details are set forth below with reference to unauthorized display protection process or method 450.

At block 430, a result of the alteration in the presentation information is forwarded. In one embodiment, the result of the alteration in the presentation information is forwarded to an internal display. The internal display can resolve the adjustments made in block 420 and display a correct image corresponding to the presentation information.

FIG. 4B is a block diagram of exemplary unauthorized display protection process or method 450 in accordance with one embodiment of the present invention. In one embodiment, unauthorized display protection process 450 is utilized in block 420 of exemplary graphics processing method 400. In one embodiment, a display interface compatible with the display port standard specification protocol is utilized and a sideband communication signal that indicates what protocol is supported.

At block 451, a feature of a display is determined. In one embodiment, a determination includes an examination of the level of anticipated security an active display configuration can provide. For example, whether the display is an internal or external display. In one exemplary implementation, a determination is made if the display is capable of resolving or decoding presentation information signaling transmitted in accordance with alterations of the present invention. In one embodiment, a control bit associated with a display indicates if the display is internal or external.

In one embodiment, a control bit associated with a display is set to indicate a display characteristic. For example, the bit can indicate if the display and/or communications to the display are secure or if communications to the display are unsecured and user accessible in an unprotected format, whether the display is an internal or external display, etc. Such displays may be subject to special consideration under premium content license terms, including pre-approval for playback of protected content without requiring content protection technology as is typically used for external displays on user-accessible connectors. In one embodiment, a mode of operation corresponding to an internal display or an external display is reported back to an application. The control bit can be reflected in a status bit. In one exemplary implementation, the control bit is set by software.

It is appreciated the control bit can be protected. The control bit can be signed by a secure crypto engine (e.g., in hardware, software, firmware, etc.). A signature can be presented together to a content player application software in the system, allowing the player to discern the presence of a compliant internal display. In one exemplary implementation an upstream protocol (e.g., a cryptographic protocol for signing display status) can be used.

At block 452, a characteristic in the graphics data signal is introduced to distort the graphics data signal from being accurately processed by an unintended display. In one embodiment, the characteristic introduced in the graphics data signal introduces an incompatibility that results in an undecipherable and distorted display presentation.

It is appreciated there are a variety of characteristics that can be introduced or altered in the signal. In one embodiment, introducing a characteristic includes utilizing different reset values based upon the feature of the display (e.g., whether the display is internal or external). Introducing a characteristic can include utilizing different fill start and end value configurations based upon the feature of the display. Different blanking start and end value configurations based upon the feature of the display can be utilized.

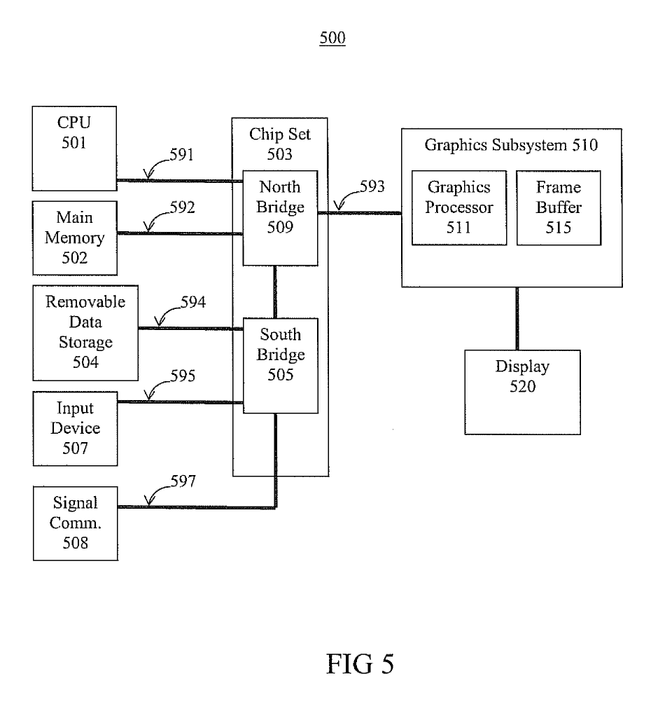

FIG. 5 is a block diagram of an exemplary computer system 500, one embodiment of a computer system upon which embodiments of the present invention can be implemented. Computer system 500 includes central processor unit 501, main memory 502 (e.g., random access memory), chip set 503 with north bridge 509 and south bridge 505, removable data storage device 504, input device 507, signal communications port 508, and graphics subsystem 510 which is coupled to display 520. Computer system 500 includes several busses for communicatively coupling the components of computer system 500. Communication bus 591 (e.g., a front side bus) couples north bridge 509 of chipset 503 to central processor unit 501. Communication bus 592 (e.g., a main memory bus) couples north bridge 509 of chipset 503 to main memory 502. Communication bus 593 (e.g., the Advanced Graphics Port interface) couples north bridge of chipset 503 to graphic subsystem 510. Communication buses 594, 595 and 597 (e.g., a PCI bus) couple south bridge 505 of chip set 503 to removable data storage device 504, input device 507, signal communications port 508 respectively. Graphics subsystem 510 includes graphics processor 511 and frame buffer 515.

The components of computer system 500 cooperatively operate to provide versatile functionality and performance. In one exemplary implementation, the components of computer system 500 cooperatively operate to provide efficient and effective protection of content presentation on an internal display. Communications bus 591, 592, 593, 594, 595 and 597 communicate information. Central processor 501 processes information. Main memory 502 stores information and instructions for the central processor 501. Removable data storage device 504 also stores information and instructions (e.g., functioning as a large information reservoir). Input device 507 provides a mechanism for inputting information and/or for pointing to or highlighting information on display 520. Signal communication port 508 provides a communication interface to exterior devices (e.g., an interface with a network). Display device 520 displays information in accordance with data stored in frame buffer 515. In one exemplary implementation display device 520 is an internal display. Computer system 500 can also have an additional external display (not shown). Graphics processor 511 processes graphics commands from central processor 501 and provides the resulting data to frame buffer 515 for storage and retrieval by display monitor 520.

It is appreciated that the present invention can be implemented in a variety of embodiments. In one exemplary implementation the present invention can be utilized in processing systems utilized to provide a variety of graphics applications including video games. For example, the present invention can be utilized to facilitate display presentation in a game console, personal computer, personal digital assistant, cell phone or any number of platforms. It is also appreciated that references to video game application implementations are exemplary and the present invention is not limited to these implementations.

Thus the present systems and methods facilitate efficient and effective protection of information in a variety of system configurations. The present systems and methods do not require complex and resource intensive techniques such as HDCP for internal displays. The protection can be provided while remaining compliant with standard specifications (e.g., Display Port Specification). The present systems and methods can facilitate convenient and flexible alternatives to system component manufactures and licensed content providers that facilitates controlled authorized display on internal displays while preventing inappropriate display of content on an external display.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A graphics processing system comprising:
an input component for receiving presentation data;
an unauthorized display protection component for introducing a non-standard alteration to a presentation information signal associated with said presentation data;
an output component for forwarding results from said combination component.

2. A graphics processing system of claim 1 wherein said non-standard alteration to said presentation information signal is compatible with an authorized presentation device and not compatible with an unauthorized presentation device.

3. A graphics processing system of claim 1 wherein said non-standard alteration to said presentation information signal is compatible with an internal display and not compatible with an external display.

4. A graphics processing system of claim 1 wherein said non-standard alteration includes resetting a scrambling value to a non-standard value if said output results are forwarded to an internal display device.

5. A graphics processing system of claim 4 wherein said scrambling value is a pseudo random value.

6. A graphics processing system of claim 1 wherein said scrambling value is altered to introduce a discontinuity in the ability of an external display receiver to unscramble said output results.

7. A graphics processing system of claim 1 wherein said unauthorized display protection component includes a left feed shift register LFSR.

8. A graphics processing method comprising:
receiving presentation information;
performing an unauthorized display protection process on said presentation information; and
forwarding result of said alteration in said presentation information.

9. A graphics processing method of claim 8 wherein said unauthorized display protection process introduces a characteristic in said graphics data signal that renders said graphics data signal compatible with an internal display while distorting said graphics data signal in a manner that is not compatible with accurate presentation by an external display.

10. A graphics processing method of claim 8 wherein said unauthorized display protection process includes altering a stuffing begin signal character and stuffing end signal character to a value compatible with an internal display while not compatible with accurate presentation by an external display.

11. A graphics processing method of claim 8 wherein said unauthorized display protection process includes modifying control signals to be compatible with an internal display while not compatible with accurate presentation by an external display.

12. A graphics processing method of claim 8 wherein said unauthorized display protection process includes utilizing a non-standard value loaded in a linear feedback shift register of the parallel pixel data to serial conversion unit in a graphics when forwarding graphics information to an internal display.

13. A graphics processing method of claim 8 wherein said unauthorized display protection process includes determining whether a display is internal or external.

14. A graphics processing method comprising:
determining a feature of a display a graphics data signal is forwarded to; and
introducing a characteristic in said graphics data signal to distort said graphics data signal from being accurately processed by an unintended display.

15. A graphics processing method of claim 14 wherein said determining said feature includes determining if a display is an internal display.

16. A graphics processing method of claim 14 wherein said determining said feature includes determining if a display is an external display.

17. A graphics processing method of claim 14 further comprising reporting to an application whether a display is an internal display or external display.

18. A graphics processing method of claim 14 wherein said introducing a characteristic includes utilizing different reset values based upon said feature of said display.

19. A graphics processing method of claim 14 wherein said introducing a characteristic includes utilizing different fill start and end value configuration based upon said feature of said display.

20. A graphics processing method of claim 14 wherein said introducing a characteristic includes utilizing different blanking start and end value configuration based upon said feature of said display.
